(19) United States
(12) Patent Application Publication
(10) Pub. No.: US 2011/0279225 A1
(43) Pub. Date: Nov. 17, 2011

(54) Methods and Apparatus for a Security Electronic Drop Safe

(75) Inventors: Louis J. Frontino, Cherry Hill, NJ (US); Bob M. Dobbins, Villanova, PA (US)

(73) Assignee: ELLENBY TECHNOLOGIES, INC, Woodbury Heights, NJ (US)

(21) Appl. No.: 13/105,951

(22) Filed: May 12, 2011

Related U.S. Application Data
(60) Provisional application No. 61/333,802, filed on May 12, 2010.

(51) Int. Cl. G05B 19/00

(52) U.S. Cl. 340/5.3

(57) ABSTRACT

Systems and techniques for providing an improved electronic safe are described. In one aspect, an electronic safe is provided with enhanced security, increased functionality and ease of use. The electronic safe may contain a camera, proximity sensor, vibration sensor and other sensors to sense and identify users. A wireless tag may be used to identify the person making deposits or also personnel making a cash pickup. The security is further enhanced by ensuring the power cannot be removed to the safe by having an internal battery backup power source and management electronics.

The present application claims the benefit of U.S. Provisional Application Ser. No. 61/333,802 filed May 12, 2010 which is incorporated by reference herein in its entirety.

### FIELD OF THE INVENTION

The present invention relates generally to improvements in electronic safes. More particularly, the present invention relates to improvements in electronic safes related to enhanced security, increased functionality, ease of use, and the like.

### BACKGROUND OF THE INVENTION

Many retail businesses commonly have at least one drop safe on site. Particularly in high cash flow transaction businesses, cashiers are required to limit the amount of cash stored in the cash drawers to a predetermined amount. Any excess cash is placed in a secure drop safe to secure the cash from potential theft. Many of these safes are rated as secure devices by independent agencies, such as Underwriter's Laboratories, which require rigorous testing to ensure they are not easily broken into. Unfortunately, given sufficient time any safe can be broken into. In most cases, the facilities that use these safes are equipped with security systems to further discourage theft. Such security systems include alarm systems, video monitoring and the like. All of these systems fall short especially when the thief is familiar with the standard systems used for security or in particular when the theft is an inside job.

Recently, a number of electronic drop safe products have become available. These electronic drop safes may have one or more bill acceptors that can determine the denomination of bills as they are inserted into the bill acceptors and store those bills in a cassette inside the drop safe. Such electronic safes may contain a deposit slot to allow envelopes or wrapped checks, bills and stamps to be inserted and stored for later retrieval. The use of electronics and bill acceptors to recognize bills also allows the reporting and tracking of money by cashier, shift and day easier to do automatically. These electronic drop safes reduce the time the manager must spend to do the counting manually, and also reduce the amount of time the money has to be exposed during those times that the money was removed from the safe to be transferred to a bank or other secured location. The use of electronic safes inherently increases the security as less cash is left exposed, the money deposited into the safe is electronically counted and in many cases the data is immediately transmitted to remote locations so the amount in the safe is always known. Further, the identity of the cashiers or managers using the safes is known by virtue of an ID code used to deposit money into the safe.

The use of these electronic drop safes added a different set of requirements for the cashiers and managers. Generally, each drop required the cashier to enter his or her identification number through a keypad, which is either on a separate box near the point of sale terminal or on the safe itself. The identification numbers or hot keys could easily be incorrectly entered causing errors in identifying the source of the deposited funds and possibly resulting in employee theft. Additionally, a considerable amount of data entry is required on the part of the manager to set up the allowed cashier identification numbers and create end of shift reports, business day reports, and the like. An identification number typically determines the authority given the manager, which if seen by other employees while the manager is entering this identification number will breech security. Collections would automatically generate collection reports that summarize the totals collected as well as the subtotals by business day, shift, and the like. A more detailed understanding of the operation of one such electronic safe can be found in U.S. patent application Ser. No. 09/960,595, filed Sep. 21, 2001 and assigned to the assignee of the present invention which is incorporated herein by reference in its entirety.

### SUMMARY OF THE INVENTION

It is an object of the present invention to provide a high security electronic safe with improved security in the event that the site security has been breached.

It is also an object of the present invention to provide added security to electronic safes by using a camera for capturing pictures of potential thieves.

It is another object of the present invention to provide techniques to determine when to capture and transmit photos of potential thieves.

A further object of the present invention is to provide a number of sensor options to determine when a theft may be in process.

It is another object of the present invention to provide an uninterruptable power supply that cannot be disabled from outside the safe.

It is a further object of the present invention to provide a means for transmitting an alarm signal as well as photos relating to a potential theft before such features can be disabled.

It is a further object of the present invention to provide a more secure approach to identifying legitimate users of the safe.

It is still another object of the present invention to provide optical recognition to identify legitimate users of the safe without any actions on the user's part.

It is yet another object of the present invention to provide electronic identification of legitimate users without the need for any actions on the user's part.

It is a further object of the present invention to provide new methods of employing RFID identification tags for user ID.

A further object of the present invention is to address one or more of the above objects in a retrofit kit for retrofitting an existing electronic drop safe.

### BRIEF DESCRIPTION OF THE DRAWINGS

FIG. 1 illustrates an electronic drop safe in accordance with the present invention.

FIG. 2 is a cutaway view showing various internal aspects of the electronic drop safe of FIG. 1;

FIG. 3 shows exemplary sensors and a camera arrangement for use with an electronic safe in accordance with the present invention;

FIG. 4 illustrates a block diagram of an electronic safe system in accordance with the present invention; and

FIG. 5 shows an exemplary RFID wrist tag and the relative positioning to the safe sensor and bill acceptors.

### DETAILED DESCRIPTION

The present invention now will be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

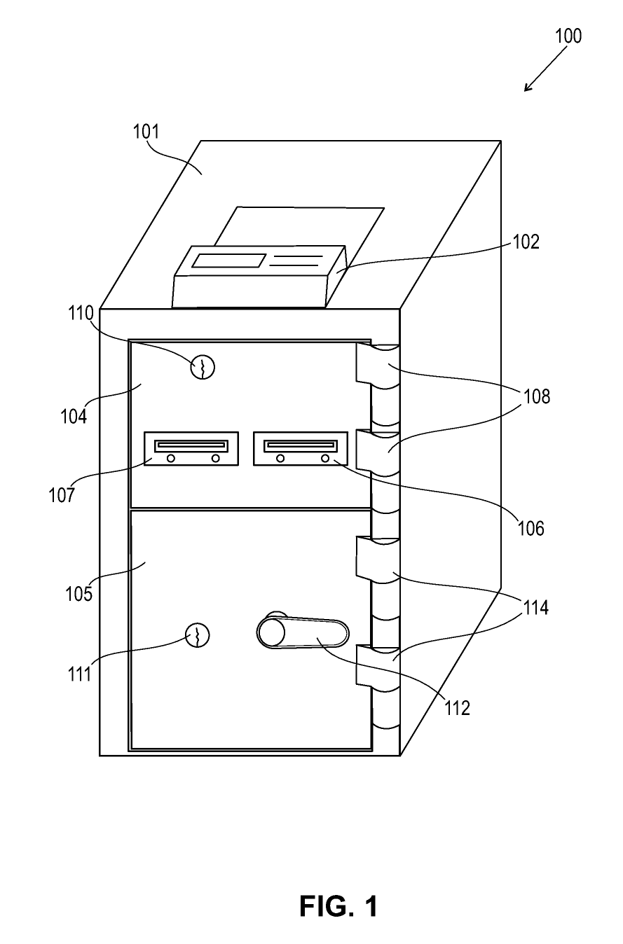

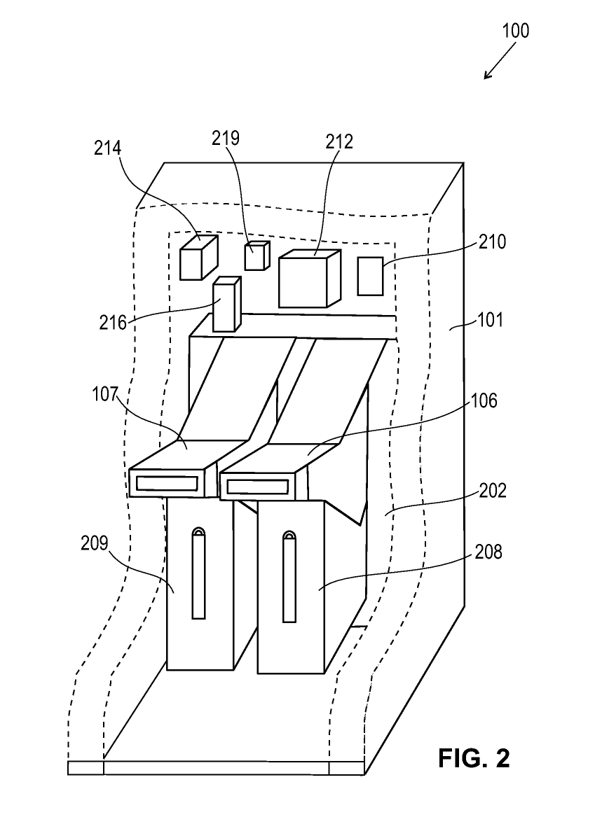

In one aspect, as shown in FIG. 1, the present invention provides an electronic safe 100 described as follows. The safe itself is typically made of steel and consists of a housing 101 and one or more doors 104 and 105. Various gauges of steel can be used with ¼″ for the housing 101 and ½″ for the doors 104 and 105 being typical. The electronic safe includes a controller 212 shown mounted inside the safe 100 in FIG. 2, and one or more bill acceptors 106 and 107 for receiving at least cash deposits. An interface module 102 is included to provide for an interface to the user of the safe and will be described in more detail later. The controller module 212 controls the operation of the electronic safe 100. The electronic safe may include a separate door 104 for access to the electronic bill acceptors and other electronic components. This first door may use a lock 110 and typically has openings to access one or more bill acceptors, 106 and 107. The door 104 will open and close by pivoting about hinges 108. A more detailed discussion of the use of two doors to improve security is contained in U.S. Pat. No. 7,516,832, assigned to the assignee of the current invention and incorporated herein by reference in its entirety.

A second door 105 is used to secure the cash which has been accepted through the bill acceptors 106 and 107 and deposited by these bill acceptors to cassettes housed behind door 105. The security of this door is more critical than that of door 104 as the money is protected in this compartment. Security lock arrangements are used for this purpose. Such security locks may be key locks, combination locks or electronic locks opened with an electronic key or directly by the controller when the ID of the person trying to open the safe is verified. This will be discussed further below. It is usual, however, to have a handle 112 to open this secure door. This door also opens by pivoting about hinges 114.

FIG. 2 shows a cutaway view of the safe 100 to better illustrate and represent an arrangement of internal components suitable for use in the present invention. The preferred embodiment includes the two bill acceptors 106 and 107 which accept bills fed into them by the user. The bill validators also include cassettes 208 and 209 to store the accepted bills. These bill cassettes 208 and 209 are accessible through door 105 as described above. The bill validators 106 and 107 are mounted into the safe housing 101 into a validator frame 202 to secure the bill validators and ensure the alignment to both the top door 104 access slots and the bottom door 105 security. Typically, the back wall of the safe 100 will contain an interface plate 210 to allow cables to interconnect the power and signals from the inside of safe 100 to the external environment. The electronic controller 212 provides the intelligence for operating the safe. One or more vibration or tilt sensors 214 is mounted within electronic drop safe 100. In FIG. 2, vibration sensor 214 is mounted on an internal back wall of the safe.

The current invention includes an internal back up battery 216 to provide backup power in the event power is removed. Power management electronics may be provided through an additional electronics component 219 which interfaces to the safe controller 212. Providing the battery backup as a separate upgradeable or retrofit package further allows field upgrades to prior technology safes to achieve the advantageous features resulting from the use of the power protection solution of the invention as further described below.

It is well known in the art to use uninterruptable power supplies (UPS) technology to ensure power is available when the power normally supplied by the electric company fails. However, these commercial UPS products are typically large and are external to the electronic drop safe 100. They are utilized to provide an external source of AC power when the utility source power is removed, for example, during a power outage at a convenience store where an electronic drop safe or safes are employed. These UPS products, however, do not present a determined thief from removing power from a drop safe. First, the thief cuts main power, for example, by unplugging the safe, throwing a breaker or cutting an electric line to the safe, and then, the UPS is disconnected or otherwise disabled. In many cases, an external UPS can just as easily be disconnected as the power cord. Thus, there are two primary requirements that the battery backup solution of the current invention addresses. The first is to provide power when power is removed in an effort to steal money from the electronic safe. In the case where power is removed, since the electronic safe monitors the opening and closing of doors, as well as, the removal of the bill cassettes 208, the absence of power results in these activities being missed. If the electronics controller 212 does not have a source of power, it does not recognize the doors opening or that money is removed by removing the cassettes 208 and 209. A thief, and in particular a thief familiar with the location can easily remove power from the safe, break into the safe, or possibly even have legitimate access to the safe in the case of an inside job, remove the money and not trigger the usual alarms that the safe would have. In many cases, safes are networked to the POS terminals, backroom computers or remote locations, for example, through wireless cell modems or Ethernet connections, and any door openings or collections are instantly reported.

The unique battery backup of the present invention makes the removal of power impossible without first opening the door of the safe. This door opening, of course can be detected, and an alarm can then be sent before the internal power source can be removed. There are some safes that provide an external power switch. The safe of the current invention would either eliminate this switch or automatically switch over to battery backup power upon such a switch being turned off.

A second reason for the battery backup UPS is to provide sufficient power to allow all the outstanding cash in the facility to be deposited into the electronic safe in the event of a legitimate power failure at a business employing such a safe or safes. In order to achieve this goal, at least an hour's backup time is usually preferred. The nature of typical external UPS products is to supply the power in the same format as the AC line source, in the United States at 120 VAC. The UPS products convert battery power through the use of inverter circuitry to high voltage AC power. The safes then typically convert this high voltage AC power back down to low voltage DC (typically 12 to 24 VDC) to operate the control electronics and bill acceptors. Thus, there are considerable conversion losses both in the conversion to 120 VAC and then back to 12 to 24 VDC. The current invention switches the internally mounted back up batteries, such as lead cell batteries similar to those used in typical external UPS products, for example, to the low voltage 12 to 24 VDC supply directly without any conversions. This approach has the advantage of deriving significantly more time and usable power from the same battery source as provided by the typical external UPS. Both extended time and efficiency are realized in addition to a significantly lower cost as the conversion electronics and the separate packaging of an external UPS are eliminated by the approach of the present invention.

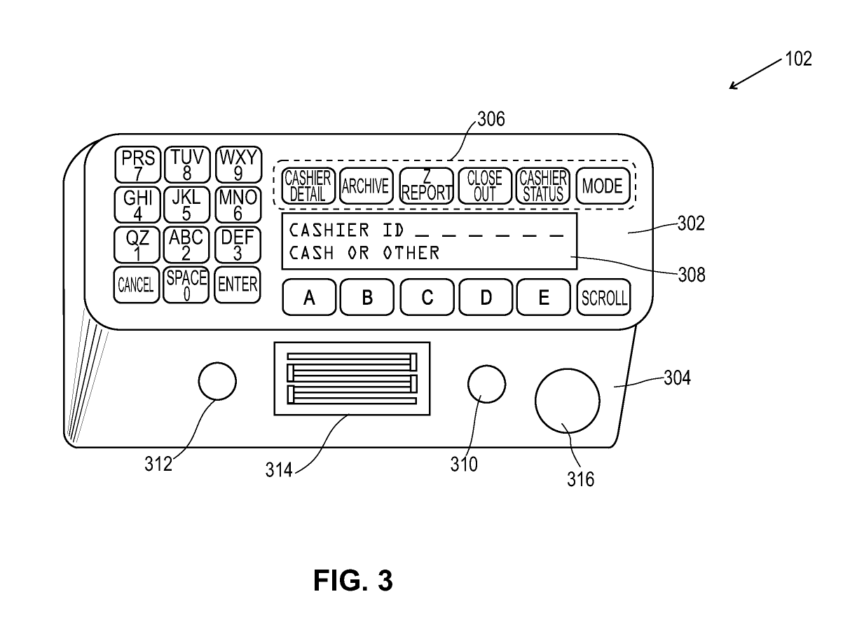

Referring now to FIG. 3, the interface module 102 is shown in detail to illustrate representative user interface features. The interface module can of course be integrated with the control electronics (if user accessible), detached from the safe or integrated into the safe as in the current preferred embodiment. Included in the interface module is a keypad 302 shown in a touch sensitive configuration with a number of individual switch inputs 306. The keypad can be of any type and can be buffered within the interface module, sent individually, or matrixed to the control electronics. A display 308 is also included for user instructions and information. Suitable types of display include LCD, LED, VFD and the like.

The display and keypad assembly is shown mounted in an enclosure 304 which is mounted to the top of the safe 100 in a presently preferred embodiment. Included in the interface module is a receiving antenna 314 used to receive close range signals as described below. The antenna itself can be a separate component or integrated into a circuit board. In particular, the antenna can be integrated into the keypad 302 circuit board to minimize cost and save space. The antenna received data is coupled to the control electronics for further processing as described below.

One weakness of many current electronic safe products is the requirement that the cashier enter an identification number (ID) through the use of a keypad, such as keypad 302. In many cases, a single hot key is utilized to enable the bill acceptor in the safe. The identification information is crucial to tracking the amount of cash put into the safe by a given cashier. In the general case in which multiple cashiers are sharing one safe, an error in entering the hot key, or forgetting to enter the ID and depositing bills into the safe before the previous cashier ID has timed out causes errors in the reporting. Insofar as the integrity of the reporting capabilities is an important timesaving benefit provided by the safes, these easily committed errors are problematic. To ensure the integrity of the collection data, at least some armored car services are providing the collectors with memory keys, which serve to identify them and act as the key to the electronic lock provided on the safe requiring the carrier to position the key within a receptacle to achieve the necessary communication with the electronic safe controller. In many cases, both the armored car employee and the store manager must have keys and/or electronic keys to allow the electronic lock to be opened. As discussed, using a keypad to enter ID information is a security risk and keys or electronic keys that are carried in pockets, and the like, can be lost. The use of an RFID key in a form that does not have to be retrieved, since it can be worn, addresses such security concerns. Where an electronic lock is employed, the armored car employees making pickups can employ an RFID key to speed pickup. The present invention solves the competing requirements of quick ID entry with the need for a reliable secure ID determination through the use of a wireless communicator.

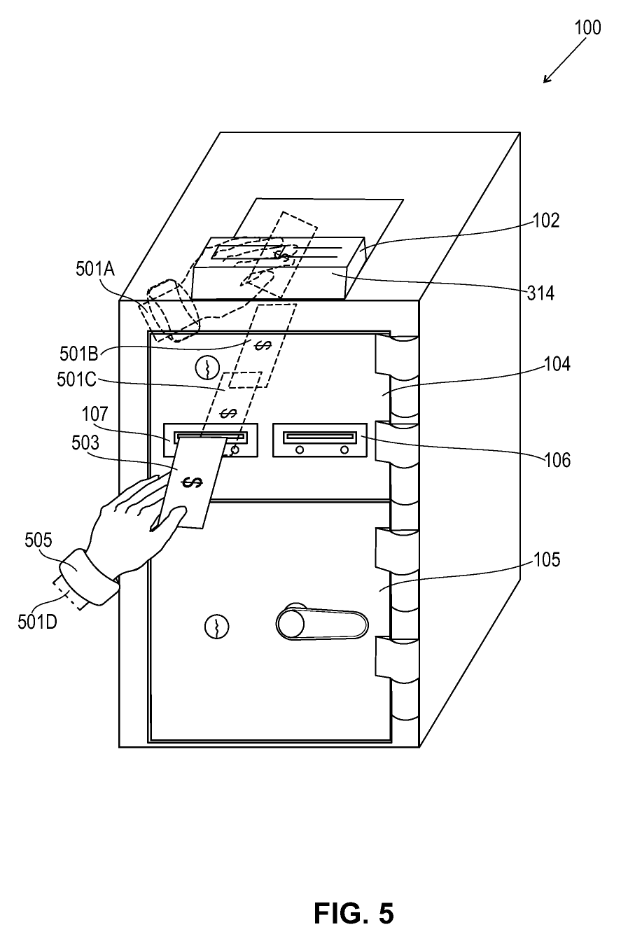

An electronic safe in accordance with the present invention provides a wireless link with a relatively small field of view near the bill acceptor entry slot best shown in FIG. 5. Each cashier will have a wireless ID tag 505, which may be worn like a wristwatch, a name tag or the like. The ID tag will have the cashier's unique identification and will automatically communicate the ID as each bill 503 is inserted. As the cashier or authorized manager moves their hand down past the receiver 314 toward the bill acceptors 106 and 107, the ID is recognized through the RF link and the drop authorized by the control electronics. One such typical moment is illustrated in FIG. 5 which shows a user's hand, ID tag 505 and bill 503 moving from positions 501A, 501B, 501C and 501D. The electronic safe wireless link constantly polls for a cashier or other user and the cashier or other user's wireless link will respond to the poll. This approach keeps the power requirement within the wireless tag very low allowing it to be conveniently serviced by a small replaceable or rechargeable battery. In a preferred embodiment, the wireless energy of the transmitter mounted in the safe is used to power the small lightweight RFID tag device worn by the cashier, allowing the ID device to operate without a battery.

This feature can be used by the store manager or other authorized personnel, such as the armored car employee, to trigger reports, act as an electronic key if an electronic lock is used, or the like. Third party collectors can similarly have a wireless ID tag to replace the need for a special key, memory module, or keying in an ID on a keypad. The use of keypads to enter the ID of managers, and third party collectors represents a significant security risk as the watchful eyes of unauthorized people could allow improper access to the secure information or the combination to the safe. All the technology available to memory keys including changing the ID day to day, restricting use by time of day, making obsolete the ID of personnel who have left the company, and the use of various encryption algorithms to prevent the electronic decoding of codes can be used on the wireless ID keys.

Such approaches eliminate both the errors associated with entering ID's through the keypad and the security risks associated with entering ID's through the keypad while increasing the speed of the drops. Timeouts to end a drop may be instantly overwritten when a different cashier enters a bill into the bill acceptor. FIG. 5 shows an RFID tag in the form of a bracelet 505 as it moves through positions 501A through D. The controller module 212 may house the drive circuitry for the RFID tag, or it may be external to the controller. The RF identification tag antenna 314 can be mounted in an interface module 102 as shown in FIG. 3, or in any other suitable location such as near the bill acceptors 106 and 107.

Referring again to FIG. 3, the current invention provides a camera 312 mounted discreetly within the safe 100 and directed to view the face of anyone approaching the safe. In a preferred embodiment of the current invention, the camera 312 is mounted on the display and keypad assembly 102 on the sloped front surface 304 to position the camera 312 facing upward toward the user. There are a number of commercially available small cameras that can be used, although one with IR or night vision is preferred. In addition to the camera, an optional proximity sensor 310 can also be mounted close to the camera 312 and can be used to enable the camera when the presence of a person is detected.

In a presently preferred embodiment of the current invention, the control electronics monitor the proximity sensor 310 and can be programmed to enable the proximity sensor during certain times when the presence of a person should not occur. For example, if a facility is closed at night, the proximity sensor would be enabled to detect any person present at night and if so detected could send an alert to a host system that an unauthorized presence may have been detected. Further, the control electronics would enable the camera 312 to take pictures or video of the intruder and transmit these as well. Of course the use of a camera with night vision would be preferred, but in the absence of night vision an additional light source, preferably an LED light source (not shown) could be turned on to provide the necessary light for the camera to effectively identify the intruder.

In addition to capturing any unintended intruder as described above, the use of the camera can be activated on all drops and collections. This approach would allow a picture of the cashier or manager to be collected at each use and time stamped. These pictures can be stored at the safe and transmitted only if a questionable transaction occurs. Alternatively, they could be sent to a host system in real time.

With the anticipated refinement in recognition software, the use of a camera can also be an alternative to other more common ID technologies, some of which are described above. Rather than entering an ID, using a key or memory device, or using an RFID wrist band, the camera can be used as the sole source of ID recognition. Of course, each user would have to be set up as an authorized user by having the camera store their image.

If very high security is required, each collection attempt can force a remote verification ensuring the images sent of the person attempting to gain access to the safe is authorized. A confirming signal would have to be received before the electronic lock would be opened.

In the case that a would be thief has knowledge of the security measures described above and can avoid them using techniques such as covering the camera, defeating the communications means and the like, the current invention provides additional security measures to further discourage attempts to break into the safe. Internally mounted vibration sensors 214 shown in FIG. 2 would detect attempts to break or drill into the safe, as well as, an attempt to move the safe from the store or other environment where it is installed. Even if the camera is covered or disabled, the signal from these vibration sensors could be used to transmit an alert to the host system. Various types of vibration sensors are commercially available including piezoelectric sensors which would mount on the inside of the safe housing and interface to the control electronics.

Each of the security measures described in the current invention proposes the use of a communications means to transmit alarms and data to a host system. In the event the communications means is defeated or the host system is not operational, the controller can determine these conditions and alternatively store the relevant data, and sound an alarm using an audio device 316 shown in FIG. 3. A standard beeper with high decibel output or a speaker are suitable. The use of the audio device can be the default choice by the controller if the safe cannot otherwise communicate to a host or it can be enabled along with the primary communication means to further encourage a thief to abort their attempts.

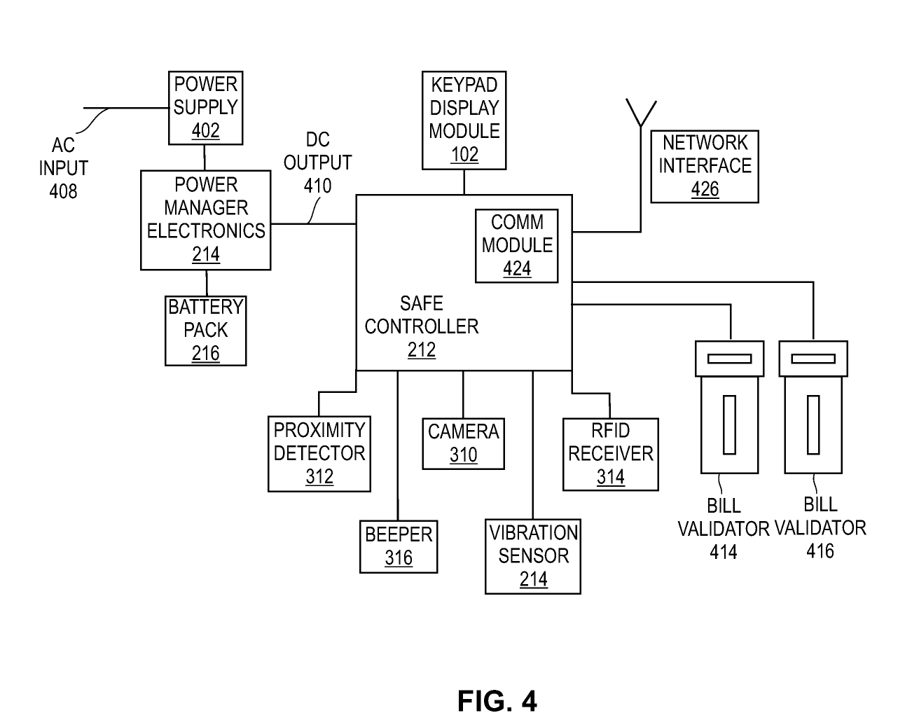

Referring to FIG. 4, a system diagram shows the relationship between the various components described above for a preferred embodiment of the current invention. The safe controller 212 consists of a microcomputer or microprocessor, program memory storage, data memory storage as well as the interface logic for the display and keypad, bill acceptors, as well as a number of sensor inputs and device outputs as described above. The safe controller 212 can also contain the power supply electronics internally or rely on an external power supply electronics component 219 as shown. The safe controller 212 can also contain the communications module 424 internally or externally. The safe controller 212 controls the operation of the electronic safe and all the interfaces to the electronic safe.

Power is supplied to the electronic safe from the available AC power 408, 120 VAC in the US, and is converted to a lower voltage, typically 12 or 24 VDC using a power supply 402 as shown. Typically, a switching power supply will be used to conserve energy and reduce heat. The current invention also provides for an internal battery 216 input to be used in the event power fails or is removed. The power manager electronics circuitry 214 monitors the output of the power supply 402 and when this regulated output falls below a predetermined level, switches automatically to the battery 216 to supply power. The battery can be any suitable voltage with 12 or 18 VDC being preferred. Since the power manager electronics 214 monitors and switches the voltage from the output of the power supply 402 directly to output voltage of the battery 216, there is no need for additional conversions from the DC output voltage of the battery back to AC line voltage as is the manner in which external commercial uninterrupted power supplies (UPS) are utilized. This allows significant improvement in efficiency as well as lower cost to be achieved. Housing the battery pack 216 and power manager electronics 219 internal to the safe prevents a thief from disabling the safe even if power is purposely removed. Unlike an internal small battery or capacitor commonly found in many electronic products which simply supplies sufficient power to power down quickly or maintain dynamic memory, the battery 216 preferably provides sufficient power to allow legitimate users to continue to deposit cash in the event of a power outage, to power the camera and detect unauthorized attempts to remove cash and potential robbery attempts for periods up to an hour or longer, and to communicate legitimate deposits.

The safe controller 212 interfaces with the camera 310 and can enable or disable its operation. The safe controller 212 also controls communication through the communications module 424 which in a preferred embodiment uses a wireless network interface transmitting data through an antenna 426 to a remote host system. Hence, the controller can take the data received from the camera and transmit it to a host system when conditions are likely to exist whereby a theft is being perpetrated. More specifically, the camera 310 can be activated whenever a drop is being made, a collection is being made, during certain times of the day or under remote, such as host system control for general monitoring of the safe surroundings.

Additionally, a proximity detector 312 can be used to determine when there is a person present near the safe and the camera 310 can be activated at these times. Another option in the safe of the current invention is to also activate the camera when vibration is detected through the vibration sensor 214. Of course, the use of the proximity detector 312 or vibration sensor 214 can trigger an alarm message to be sent from the safe controller 212 to the host system through the communications module 424 whether the camera 310 is used or not.

In an effort to further discourage a thief, any of the sensors described above can also trigger the safe controller 212 to sound an alarm through the beeper 316. The loud piercing sound may be enough to send the thief running.

The safe controller 212 interfaces with the RFID or other wireless receiver 314 to allow communication with the RFID or other wireless wrist strap 505. Detection of the RFID information from a cashier or manager can be used to identify the person and substitute for the keypad 102 entry or other form of user identification otherwise required. This approach provides both added security as incorrect identification information cannot be entered as well as increase speed of operation as keys do not need to be depressed or other actions taking time from the cashier performed.

It will be apparent to those skilled in the art that various modifications and variations can be made in the present invention without departing from the spirit and scope of the present invention. As one example, the combination of sensors, control functionality and internal battery backup described herein can be employed in a wide variety of advantageous combinations to provide continued operation when power is lost under legitimate circumstances and to provide significantly enhanced security when power is lost as part of an attempt to rob an electronic safe. Upon detection of loss of AC power by a controller, such as controller 212, power is automatically switched over to the internal battery backup which has sufficient power to continue normal operations allowing a checker to deposit cash for a pending transaction when power was legitimately lost. In such an instance, the legitimate checker's identification is sensed, for example, by RFID receiver 314 sensing wrist bracelet 505, as banknotes are deposited. The banknotes are sensed by bill validator 106 or 107 and stored in a respective cassette 208 or 209. Where power is lost as part of an attempt to rob an electronic drop safe, such as safe 100, if proximity is then sensed by a sensor, such as sensor 310, or tilting or drilling are detected by a sensor or sensors, such as sensor 214, this combination of events is advantageously employed to trigger camera 312 and to communicate a break in situation using communication module 424, for example. More and less sensors and alarms, such as, audio alarm 316 may be brought into play as desired based on the teachings herein and the context in which the invention is employed. Thus, it is intended that the present invention covers such modifications and variations of this invention provided they come within the scope of the appended claims and their equivalents.

We claim:

1. An electronic safe for accepting and recognizing cash deposits comprising:
at least one bill acceptor for accepting the cash deposits;
a controller for controlling the operation of the at least one bill acceptor, and for receiving an indication of the value of the cash deposits;
a cassette for storing the cash deposits from the at least one bill acceptor;
a camera for taking pictures of both legitimate and illegitimate attempts to access the electronic safe; a proximity sensor for detecting proximity to the electronic safe outside periods of legitimate use; and
a vibration sensor for detecting improper movement or an attempt at improper access to interior of the electronic safe.

2. The electronic safe of claim 1 further comprising a data entry apparatus for entering the identification of users.

3. The electronic safe of claim 1 further comprising a communications apparatus for communicating data to a remote location.

4. The electronic safe of claim 1 wherein the camera is positioned to allow the face of a user to be recorded.

5. The electronic safe of claim 1 further comprising an access door with an electronic lock which is opened utilizing a wireless device carried or worn by a service person authorized to make a pick up from the electronic safe.

6. The electronic safe of claim 1 wherein the vibration sensor is mounted on the inside of the electronic safe so as to allow the detection of attempted drilling or use of a striking or crowbar device.

7. The electronic safe of claim 2 wherein the data entry apparatus comprises a wireless device carried or worn by the user and a wireless receiver mounted on the safe.

8. The electronic safe of claim 7 wherein the wireless device carried or worn by the user is a wristband incorporating an RFID tag.

9. The electronic safe of claim 7 wherein the wireless device is an RFID tag and wireless receiver is an RFID receiver.

10. The electronic safe of claim 9 wherein the wireless device carried or worn by the user receives its power from the wireless receiver in the safe.

11. The electronic safe of claim 3 wherein the communication apparatus for communicating data to a remote location is a wireless system.

12. The electronic safe of claim 4 wherein the camera image is used to identify the user.

13. The electronic safe of claim 12 wherein the identified user is compared to a pre-existing user image file to determine the Identification of the user for authorizing them for drop or collection access.

14. The electronic safe of claim 4 wherein the camera is enabled and images recorded are transmitted to a remote host when a theft may be in process.

15. The electronic safe of claim 4 wherein the camera is enabled when the proximity sensor and vibration sensor are activated during predetermined times that no presence is expected, and upon detection of any event by the proximity sensor or the vibration sensor, the camera is activated and recorded images are saved or transmitted to a host system.

16. An electronic safe for accepting and recognizing cash deposits comprising:
at least one bill acceptor for accepting the cash deposits;
a controller for controlling the operation of the at least one bill acceptor, and for receiving an indication of the value of the cash deposits; and
a cassette for storing the cash deposits from the at least one bill acceptor;
a primary power source for supplying power to the safe electronics and bill acceptors;
a battery mounted within the electronic safe for power backup should the primary power source fail or be disconnected; and
battery management electronics mounted within the electronic safe for managing the switching between the primary power source and the battery for power backup, wherein said battery provides sufficient power for extended operation upon external disabling of normal alternating current power.

17. The electronic safe of claim 16 wherein the battery for power backup has sufficient power to allow continuing safe operation including continued cash deposits by authorized personnel and normal reporting functions during power failures

18. The electronic safe of claim 16 wherein the battery management electronics signals to the safe electronics the use of the battery for power backup.

19. The electronic safe of claim 18 wherein the safe electronics upon receiving a signal from the battery management electronics transmits an alarm signal to a remote system.

20. A method of operating an electronic safe for accepting and recognizing cash deposits comprising:
detecting a person in proximity to the electronic drop safe utilizing a sensor;
determining if a condition exists indicative of a potential threat situation;
undertaking a security routine comprising one or more of:
taking a picture with a security camera;
switching over to an internal uninterruptable DC voltage battery supply; and
reporting the potential threat utilizing wireless communication.
